(19) United States
(12) Patent Application Publication
(10) Pub. No.: US 2026/0354548 A1
(43) Pub. Date: Nov. 12, 2026

(54) DROP-PROOF PROTECTIVE CASE

(71) Applicant: Shenzhen Deone Innovation Technology Co., Ltd, Shenzhen (CN)

(72) Inventors: HUAYONG XIE, Zhanjiang (CN); LEI YU, Shenzhen (CN); QIANG LIU, Jingzhou (CN)

(21) Appl. No.: 19/727,581

(22) Filed: Jul. 1, 2026

(30) Foreign Application Priority Data
Aug. 7, 2025 (CN) 202521671453.7

(51) Int. Cl. A45C 11/00; A63F 13/98

(52) U.S. Cl. CPC A45C 11/003; A45C 11/002; A63F 13/98

(57) ABSTRACT

A drop-proof protective case is used for housing an electronic device, and includes a shell. The shell defines a receiving chamber. Elastic engaging parts are arranged on a side, facing the receiving chamber, of the shell. A length direction of the electronic device is defined as a first direction, and a width direction of the electronic device is defined as a second direction. The elastic engaging parts are engaged with two opposite ends of the electronic device in the first direction and also engaged with two opposite ends of the electronic device in the second direction. The elastic engaging parts are engaged with the periphery of the electronic device to avoid direct contact between the periphery of the electronic device and the shell, thereby preventing the periphery of the electronic device from being damaged due to collision.

### CROSS-REFERENCE TO RELATED APPLICATIONS

This application claims priority to Chinese Patent Application No. 2025216714537, filed on Aug. 7, 2025, which is hereby incorporated by reference in its entirety.

### TECHNICAL FIELD

The present disclosure relates to the technical field of electronics accessories, in particular to a drop-proof protective case.

### BACKGROUND

Electronic devices are easily damaged due to collision, so they are often housed in protective cases. The protective case defines a receiving chamber in which an electronic device is received. When the protective case is carried, the electronic device collides with the protective case due to impact of the protective case, which in turn causes damage to the electronic device.

### SUMMARY

In view of the defects and deficiencies in the prior art, an objective of the present disclosure is to provide a drop-proof protective case. Elastic engaging parts are engaged with two opposite ends of an electronic device in a first direction and also engaged with two opposite ends of the electronic device in a second direction, so as to be engaged with the periphery of the electronic device to avoid direct contact between the periphery of the electronic device and a shell, thereby preventing the periphery of the electronic device from being damaged due to collision.

To fulfill the above objective, the technical solution adopted by the present disclosure is as follows: a drop-proof protective case is used for housing an electronic device and includes a shell, where the shell defines a receiving chamber, elastic engaging parts are formed on a side, facing the receiving chamber, of the shell, a length direction of the electronic device is defined as a first direction, a width direction of the electronic device is defined as a second direction, and the elastic engaging parts are engaged with two opposite ends of the electronic device in the first direction and also engaged with two opposite ends of the electronic device in the second direction.

By adopting the above technical solution, the present disclosure fulfills the following beneficial effects: the elastic engaging parts are engaged with the two opposite ends of the electronic device in the first direction and also engaged with the two opposite ends of the electronic device in the second direction, so as to be engaged with the periphery of the electronic device to avoid direct contact between the periphery of the electronic device and the shell, thereby preventing the periphery of the electronic device from being damaged due to collision.

### BRIEF DESCRIPTION OF DRAWINGS

To more clearly explain the technical solutions in the embodiments of the present disclosure or the prior art, drawings used for describing the embodiments of the present disclosure or the prior art are briefly introduced below. Obviously, the drawings in the following description merely illustrate some embodiments of the present disclosure, and for those ordinarily skilled in the art, other drawings may be obtained on the basis of the following ones without creative labor.

FIG. 1 is a schematic structural diagram of a drop-proof protective case in an unfolded state according to an embodiment of the present disclosure.

FIG. 2 is an exploded view of a second shell according to an embodiment of the present disclosure.

FIG. 3 is a schematic structural diagram of the drop-proof protective case in a locked state according to an embodiment of the present disclosure.

FIG. 4 is a sectional view along A-A′ in FIG. 3.

FIG. 5 is a sectional view along B-B′ in FIG. 3.

FIG. 6 is a sectional view along C-C′ in FIG. 3.

FIG. 7 is a sectional view along D-D′ in FIG. 3.

FIG. 8 is a schematic structural diagram of a first engaging part according to an embodiment of the present disclosure.

FIG. 9 is a schematic structural diagram of the drop-proof protective case in an unlocked state according to an embodiment of the present disclosure.

FIG. 10 is a sectional view along E-E′ in FIG. 9.

FIG. 11 is a schematic structural diagram of an electronic device according to an embodiment of the present disclosure.

FIG. 12 is a schematic structural diagram of the electronic device from another perspective according to an embodiment of the present disclosure.

### REFERENCE SIGNS

1000, shell; 100, first shell; 110, first soft pad; 120, first connector; 121, first extension unit; 1211, second engaging part; 12111, third guide slope; 122, first engaging unit; 123, stop portion; 200, second shell; 210, mounting groove; 220, second soft pad; 230, card slot; 240, second connector; 241, second extension unit; 242, second engaging unit; 300, slider; 310, main body; 320, third extension unit; 330, third engaging unit; 331, first engaging portion; 3311, second guide slope; 332, first guide slope; 333, sliding protrusion; 20, receiving chamber; 30, elastic engaging part; 31, first engaging part; 32, second engaging part; 33, third engaging part; 34, fourth engaging part; 35, avoidance groove; 36, engaging protrusion; 37, avoidance space; X, first direction; Y, second direction; Z, third direction; 2000, electronic device; 2001, back key; 2002, peripheral key.

### DESCRIPTION OF EMBODIMENTS

The present disclosure is described in further detail below in conjunction with the accompanying drawings.

The following specific embodiment is merely used for explaining the present disclosure rather than limiting the present disclosure. After reading the specification, those skilled in the art may make non-creative modifications to this embodiment as needed, and all these non-creative modifications within the scope of the claims of the present disclosure are protected by the patent law.

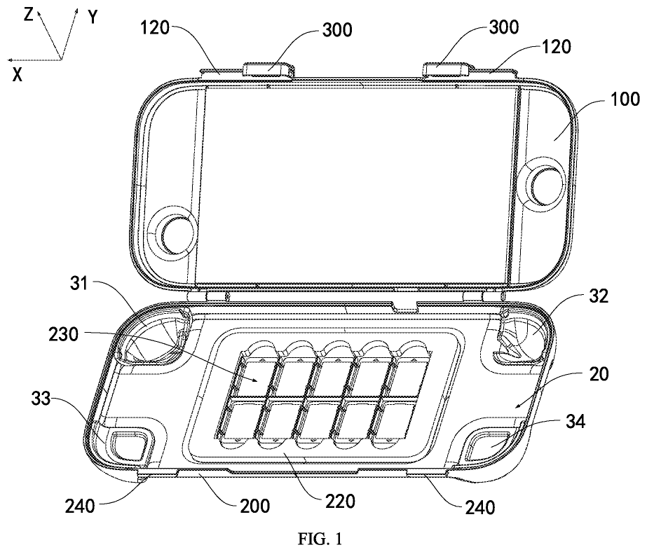

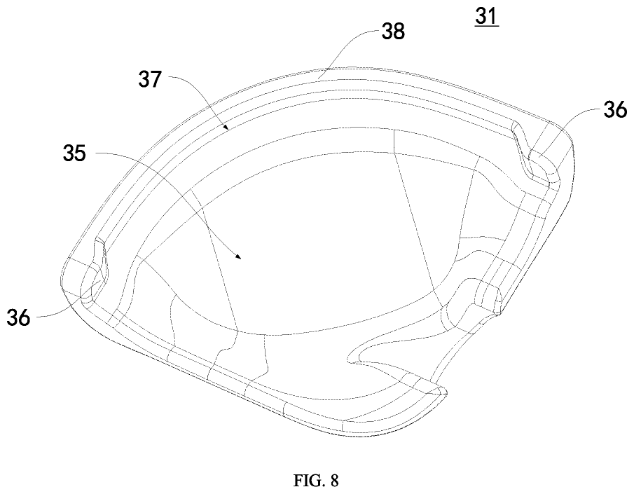

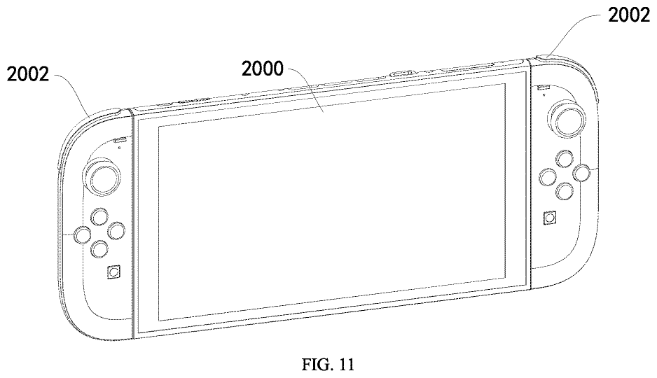

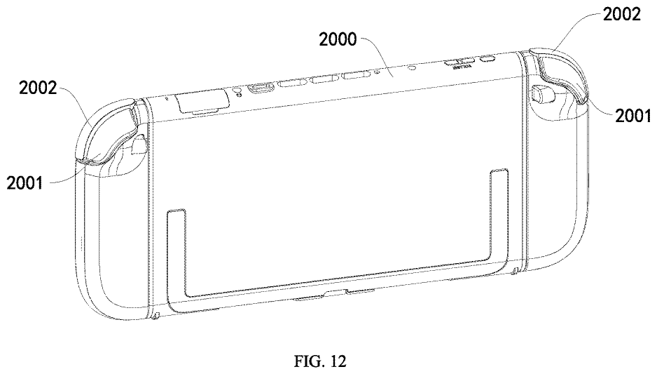

As shown in FIGS. 1-6, 8 and 11-12, this embodiment relates to a drop-proof protective case. The drop-proof protective case is used for housing an electronic device 2000, and includes a shell 1000. The shell 1000 defines a receiving chamber 20, and elastic engaging parts 30 are arranged on a side, facing the receiving chamber 20, of the shell 1000. The elastic engaging parts 30 are engaged with two opposite ends of the electronic device 2000 in a length direction and also engaged with two opposite ends of the electronic device 2000 in a width direction. The elastic engaging parts 30 are engaged with the two opposite ends of the electronic device 2000 in the length direction and also engaged with the two opposite ends of the electronic device 2000 in the width direction, so as to be engaged with the periphery of the electronic device 2000 to avoid direct contact between the periphery of the electronic device 2000 and the drop-proof protective case, thereby preventing the periphery of the electronic device 2000 from being damaged due to collision.

The length direction of the electronic device 2000 is defined as a first direction X, the width direction of the electronic device 2000 is defined as a second direction Y, and a thickness direction of the electronic device 2000 is defined as a third direction Z. The electronic device 2000 is one of a game console, a tablet computer, a mobile phone and a notebook computer. In this embodiment, the electronic device 2000 is a game console.

In an implementation mode, the elastic engaging parts 30 are ring-shaped and engaged with the periphery of the electronic device 2000, so as to be engaged with two opposite ends of the electronic device 2000 in the first direction X as well as two opposite ends of the electronic device 2000 in the second direction Y.

In another implementation mode, the number of the elastic engaging parts 30 is at least four, where at least two elastic engaging parts 30 are respectively arranged at two opposite ends of the shell 1000 in the first direction X and engaged with two opposite ends of the electronic device 2000 in the first direction X, and at least two of the other elastic engaging parts 30 are respectively arranged at two opposite ends of the shell 1000 in the second direction Y and engaged with two opposite ends of the electronic device 2000 in the second direction Y.

In another implementation mode, the number of the elastic engaging parts 30 is at least four, where four of the elastic engaging parts 30 are distributed at four corners of the shell 1000 and engaged with four corners of the electronic device 2000.

In an implementation mode, two elastic engaging parts 30 located in the first direction X of the electronic device 2000 at least partially extend towards each other to be engaged with one end of the electronic device 2000 in the first direction X. Two elastic engaging parts 30 located in an opposite direction of the first direction X of the electronic device 2000 at least partially extend towards each other to be engaged with one end of the electronic device 2000 in the opposite direction of the first direction X. Two elastic engaging parts 30 located in the second direction Y of the electronic device 2000 at least partially extend towards each other to be engaged with one end of the electronic device 2000 in the second direction Y. Two elastic engaging parts 30 located in an opposite direction of the second direction Y of the electronic device 2000 at least partially extend towards each other to be engaged with one end of the electronic device 2000 in the opposite direction of the second direction Y.

As shown in FIGS. 1-2, 4-5 and 11-12, the number of the elastic engaging parts 30 is at least four, where at least two elastic engaging parts 30 are engaged with one side of the electronic device 2000 in the second direction Y and respectively engaged with two opposite sides of the electronic device 2000 in the first direction X, and at least the other two elastic engaging parts 30 are engaged with one side of the electronic device 2000 in the opposite direction of the second direction Y and respectively engaged with two opposite sides of the electronic device 2000 in the first direction X.

In this embodiment, the elastic engaging parts 30 include a first engaging part 31, a second engaging part 32, a third engaging part 33 and a fourth engaging part 34. The first engaging part 31 and the second engaging part 32 are located on one side of the electronic device 2000 in the second direction Y, and one end of the first engaging part 31 in the second direction Y and one end of the second engaging part 32 in the second direction Y at least partially extend towards each other to be engaged with one side of the electronic device 2000 in the second direction Y. An end, away from the second engaging part 32, of the first engaging part 31 and an end, away from the first engaging part 31, of the second engaging part 32 at least partially extend in the opposite direction of the second direction Y, so as to be engaged with two opposite sides of the electronic device 2000 in the first direction X respectively. The third engaging part 33 and the fourth engaging part 34 are located on one side of the electronic device 2000 in the opposite direction of the second direction Y, and one end of the third engaging part 33 in the opposite direction of the second direction Y and one end of the fourth engaging part 34 in the opposite direction of the second direction Y at least partially extend towards each other to be engaged with one side of the electronic device 2000 in the opposite direction of the second direction Y. An end, away from the fourth engaging part 34, of the third engaging part 33 and an end, away from the third engaging part 33, of the fourth engaging part 34 at least partially extend in the second direction Y, so as to be engaged with two opposite sides of the electronic device 2000 in the first direction X respectively.

In another implementation mode, in addition to the four elastic engaging parts 30 in this embodiment, the drop-proof protective case further includes a fifth engaging part and a sixth engaging part, which are respectively arranged at two opposite ends of the shell 1000 in the first direction X and engaged with two opposite ends of the electronic device 2000 in the first direction X. The fifth engaging part is located between the first engaging part 31 and the third engaging part 33, and the sixth engaging part is located between the second engaging part 32 and the fourth engaging part 34. The drop-proof protective case further includes a seventh engaging part and an eighth engaging part, which are respectively arranged at two opposite ends of the shell 1000 in the second direction Y and engaged with two opposite ends of the electronic device 2000 in the second direction Y. The seventh engaging part is located between the first engaging part 31 and the second engaging part 32, and the eighth engaging part is located between the third engaging part 33 and the fourth engaging part 34.

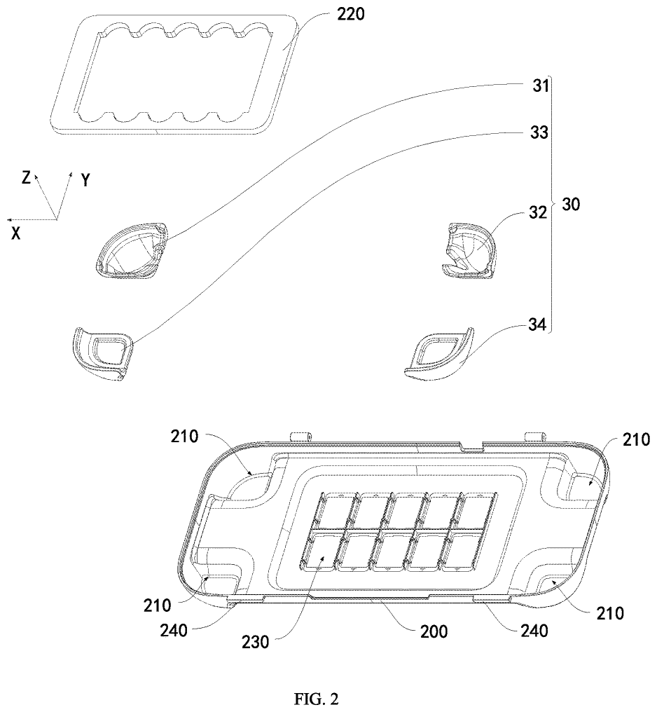

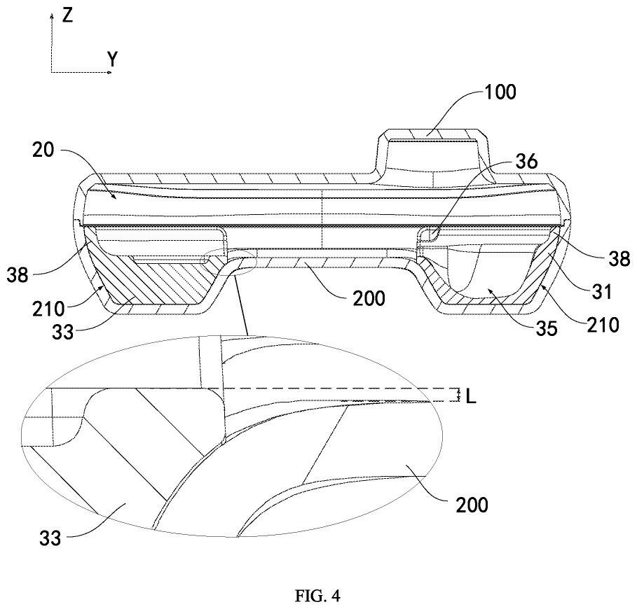

As shown in FIGS. 2 and 4, the shell 1000 is provided with mounting grooves 210, and the elastic engaging parts 30 are mounted in the mounting grooves 210.

In this embodiment, the mounting grooves 210 are formed in a bottom surface of the shell 1000, and the elastic engaging parts 30 are at least partially inlaid in the mounting grooves 210 to be assembled on the shell 1000. The elastic engaging parts 30 at least partially extend in the third direction Z to form engaging portions that are engaged with the electronic device 2000.

In an implementation mode, the mounting grooves 210 are formed in an inner periphery of the shell 1000, and the elastic engaging parts 30 are at least partially inlaid in the mounting grooves 210 to be assembled on the shell 1000. The elastic engaging parts 30 at least partially extend in a direction towards the receiving chamber 20 to form engaging portions that are engaged with the electronic device 2000.

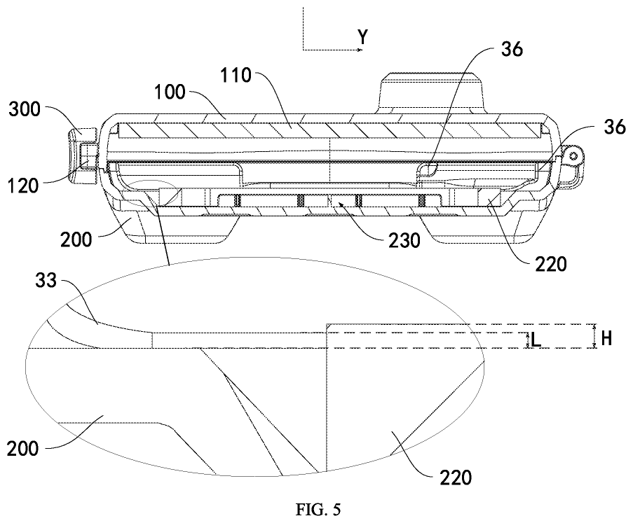

As shown in FIGS. 4-5, when the electronic device 2000 is engaged by the elastic engaging parts 30, the electronic device 2000 is spaced apart from the shell 1000.

In this embodiment, the elastic engaging parts 30 inlaid in the mounting grooves 210 at least partially extend towards the receiving chamber 20 to abut against a back side of the electronic device 2000, such that the back side of the electronic device 2000 is spaced apart from the bottom surface of the shell 1000. Moreover, the engaging portions at least partially extend outward to be engaged with the periphery of the electronic device 2000, such that the periphery of the electronic device 2000 is spaced apart from the periphery of the shell 1000.

In an implementation mode, the elastic engaging parts 30 extend towards the electronic device 2000 to be engaged with the electronic device 2000 and to space the electronic device 2000 apart from the shell 1000.

As shown in FIGS. 1-2, 4, 8 and 11-12, back keys 2001 are arranged on the back side of the electronic device 2000, and the back keys 2001 at least partially extend in the third direction Z (to be specific, in a direction from the front side to the back side of the electronic device 2000). Avoidance grooves 35 are formed in the elastic engaging parts 30 and used for avoiding the back keys 2001. When the electronic device 2000 is assembled on the shell 1000, the back keys 2001 are inlaid in the avoidance grooves 35, and the elastic engaging parts 30 abut against portions, not provided with keys, of the electronic device 2000, such that the back keys 2001 are prevented from being triggered accidentally when the electronic device 2000 is assembled onto the shell 1000.

As shown in FIGS. 4-6 and 8, peripheral keys 2002 are arranged on the periphery of the electronic device 2000, and at least two engaging protrusions 36 are formed on each elastic engaging part 30. The two engaging protrusions 36 extend towards the electronic device 2000, so as to be engaged with portions, close to the corresponding peripheral key 2002, of the periphery of the electronic device 2000. An avoidance space 37 is formed between the two engaging protrusions 36, and the avoidance space 37 is used for avoiding the corresponding peripheral key 2002. When the electronic device 2000 is assembled on the shell 1000, the engaging protrusions are engaged with the periphery of the electronic device 2000, and the peripheral keys 2002 are inlaid in the avoidance spaces 37, such that the peripheral keys 2002 are prevented from being triggered accidentally when the electronic device 2000 is assembled onto the shell 1000.

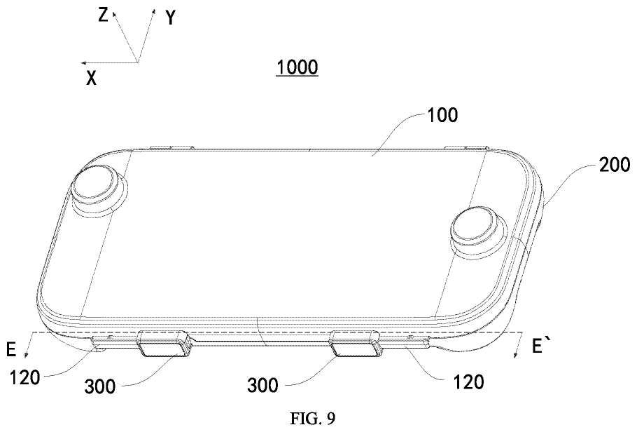

As shown in FIGS. 1-6, 9 and 11-12, the shell 1000 includes a first shell 100 and a second shell 200. A first soft pad 110 is arranged on an inner side of the first shell 100. A second soft pad 220 is arranged on an inner side of the second shell 200. In a closed state, i.e., in a state where the first shell 100 and the second shell 200 are closed together, the first soft pad 110 and the second soft pad 220 respectively abut against two opposite sides of the electronic device 2000 in the third direction Z, i.e., the first soft pad 110 and the second soft pad 220 respectively abut against the front side and the back side of the electronic device 2000. Since the elastic engaging parts 30 are engaged with the two opposite ends of the electronic device 2000 in the first direction X and also engaged with the two opposite ends of the electronic device 2000 in the second direction Y and the first soft pad 110 and the second soft pad 220 abut against the two opposite ends of the electronic device 2000 in the third direction Z, the electronic device 2000 is protected in all directions.

In this embodiment, the elastic engaging parts 30 are arranged on an inner side of the second shell 200. When the electronic device 2000 is housed in the second shell 200, a distance between the electronic device 2000 and the second soft pad 220 in the third direction Z is less than a distance between the electronic device 2000 and the elastic engaging parts 30 in the third direction Z, that is, the second soft pad 220 abuts against the back side of the electronic device 2000; moreover, a distance between the elastic engaging parts 30 and the back side of the electronic device 2000 is a first height L, and a distance between the back side of the electronic device 2000 and a bottom surface of the second shell 200 is a second height H, where the second height H is greater than the first height L. In this way, when the electronic device 2000 is assembled on the second shell 200, a side of the electronic device 2000 in the opposite direction of the third direction Z abuts against the second soft pad 220 first and is prevented from coming into contact with the second shell 200, i.e., the back side of the electronic device 2000 abuts against the second soft pad 220 and is prevented from coming into contact with the second shell 200, such that the electronic device 2000 is prevented from being damaged due to collision. Furthermore, by means of the arrangement of the elastic engaging parts 30, the second soft pad 220, when deformed, comes into contact with the elastic engaging parts 30 first, and the side of the electronic device 2000 in the opposite direction of the third direction Z is further prevented from coming into contact with the second shell 200, i.e., the back side of the electronic device 2000 is further prevented from coming into contact with the second shell 200, thus preventing the electronic device 2000 from being damaged due to collision.

As shown in FIGS. 1-2 and 5-6, card slots 230 are formed in the inner side of the second shell 200, and the card slots 230 are used for storing electronic cards. In an implementation mode, avoidance holes are formed in the second soft pad 220, and the card slots 230 are formed in spaces defined by the avoidance holes and the second shell 200, such that the electronic cards may be stored conveniently. The electronic cards include game cards and memory cards.

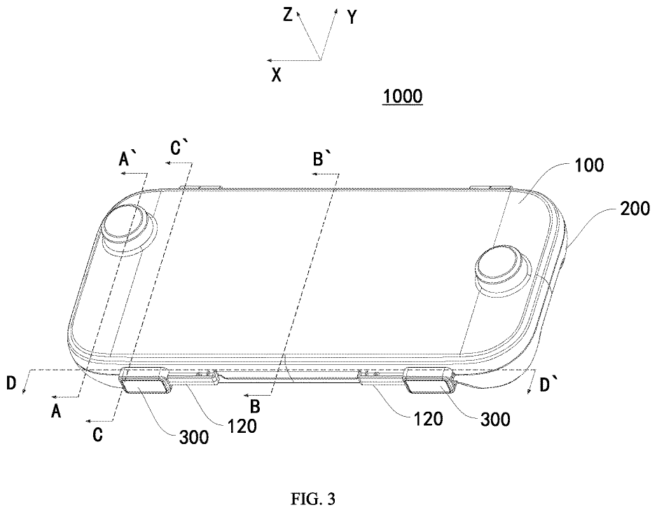

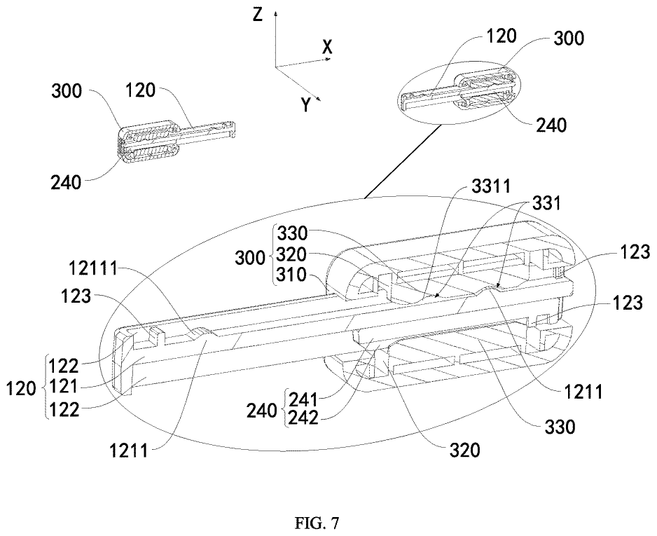

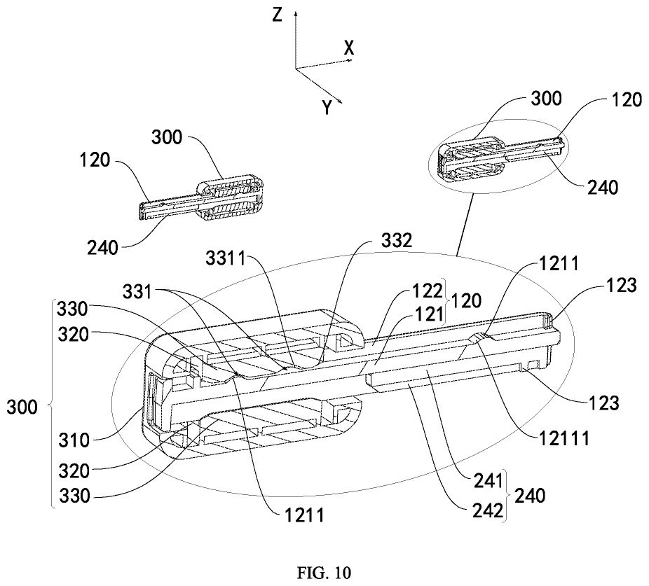

As shown in FIGS. 3, 6-7 and 9-10, the shell 1000 includes a first shell 100, a second shell 200 and a slider 300. The slider 300 is slidably arranged on the first shell 100 or the second shell 200. When the slider 300 is located in a first position, the slider 300 is engaged with the first shell 100 and the second shell 200. When the slider 300 is located in a second position, the slider 300 is disengaged from the first shell 100 or the second shell 200.

In an implementation mode, the first shell 100 is provided with a first connector 120, the second shell 200 is provided with a second connector 240, and the slider 300 is slidably arranged on the first connector 120 or the second connector 240. When the slider 300 is located in the first position, the drop-proof protective case is in a locked state, and the slider 300 is engaged with the first connector 120 and the second connector 240. When the slider 300 is located in the second position, the drop-proof protective case is in an unlocked state, and the slider 300 is disengaged from the first connector 120 or the second connector 240. In the unlocked state, the first shell 100 and the second shell 200 move relatively to enter an unfolded state and expose the electronic device 2000. The closed state includes the unlocked state and the locked state.

As shown in FIGS. 3, 6-7 and 9-10, the slider 300 is provided with a first engaging portion 331, and the first connector 120 and/or the second connector 240 is provided with a second engaging portion 1211. When the slider 300 is located in the first position, i.e., when the drop-proof protective case is in the locked state, the first engaging portion 331 is engaged with the second engaging portion 1211 to restrain the slider 300 from sliding (to be specific, to restrain the slider 300 from sliding from the first position to the second position) to improve the stability of the drop-proof protective case in the locked state, such that the first shell 100 and the second shell 200 can provide stable protection for the electronic device 2000.

In an implementation mode, as shown in FIGS. 3, 6-7, 9-10 and 11-12, the slider 300 is slidably arranged on the first connector 120, and the second engaging portion 1211 is arranged on the first connector 120. When the slider 300 is located in the first position, the first engaging portion 331 of the slider 300 is engaged with the second engaging portion 1211 of the first connector 120 to restrain the slider 300 from sliding. When the slider 300 is located in the second position, the slider 300 is disengaged from the second connector 240, such that the first shell 100 and the second shell 200 can move with respect to each other to expose the electronic device 2000.

In another implementation mode, the slider 300 is slidably arranged on the first connector 120, and the second engaging portion 1211 is arranged on the second connector 240. When the slider 300 is located in the first position, the first engaging portion 331 of the slider 300 is engaged with the second engaging portion 1211 of the second connector 240 to restrain the slider 300 from sliding. When the slider 300 is located in the second position, the slider 300 is disengaged from the second connector 240, such that the first shell 100 and the second shell 200 can move with respect to each other to expose the electronic device 2000.

In another implementation mode, the slider 300 is slidably arranged on the first connector 120, two second engaging portions 1211 are respectively arranged on the first connector 120 and the second connector 240, and correspondingly, the slider 300 is provided with two first engaging portions 331. When the slider 300 is located in the first position, the two first engaging portions 331 of the slider 300 are respectively engaged with the second engaging portion 1211 of the second connector 240 and the second engaging portion 1211 of the first connector 120 to restrain the slider 300 from sliding. When the slider 300 is located in the second position, the slider 300 is disengaged from the second connector 240, such that the first shell 100 and the second shell 200 can move with respect to each other to expose the electronic device 2000.

In another implementation mode, the slider 300 is slidably arranged on the second connector 240, and the second engaging portion 1211 is arranged on the first connector 120. When the slider 300 is located in the first position, the first engaging portion 331 of the slider 300 is engaged with the second engaging portion 1211 of the first connector 120 to restrain the slider 300 from sliding. When the slider 300 is located in the second position, the slider 300 is disengaged from the first connector 120, such that the first shell 100 and the second shell 200 can move with respect to each other to expose the electronic device 2000.

In another implementation mode, the slider 300 is slidably arranged on the second connector 240, and the second engaging portion 1211 is arranged on the second connector 240. When the slider 300 is located in the first position, the first engaging portion 331 of the slider 300 is engaged with the second engaging portion 1211 of the second connector 240 to restrain the slider 300 from sliding. When the slider 300 is located in the second position, the slider 300 is disengaged from the first connector 120, such that the first shell 100 and the second shell 200 can move with respect to each other to expose the electronic device 2000.

In another implementation mode, the slider 300 is slidably arranged on the second connector 240, two second engaging portions 1211 are respectively arranged on the first connector 120 and the second connector 240, and correspondingly, the slider 300 is provided with two first engaging portions 331. When the slider 300 is located in the first position, the two first engaging portions 331 of the slider 300 are respectively engaged with the second engaging portion 1211 on the second connector 240 and the second engaging portion 1211 on the first connector 120 to restrain the slider 300 from sliding. When the slider 300 is located in the second position, the slider 300 is disengaged from the first connector 120, such that the first shell 100 and the second shell 200 can move with respect to each other to expose the electronic device 2000.

In an implementation mode, two or more first connectors 120 are arranged, and the number of second connectors 240 and the number of sliders 300 correspond to the number of the first connectors 120. At least two first connectors 120 are respectively arranged at two opposite ends of the first shell 100 to guarantee the connection stability of the first shell 100 and the second shell 200 in the locked state, thereby guaranteeing the protection performance of the drop-proof protective case.

In this embodiment, two first connectors 120 are arranged, and the number of second connectors 240 and the number of sliders 300 correspond to the number of the first connectors 120, i.e., the number of the second connectors 240 is two, and the number of the sliders 300 is two. The two first connectors 120 are located on the same side of the first shell 100 to guarantee the connection performance of the first shell 100 and the second shell 200 on this side.

As shown in FIGS. 1-6 and 9, an end, away from the first connector 120, of the first shell 100 is rotatably connected to an end, away from the second connector 240, of the second shell 200, i.e., an end, away from the slider 300, of the first shell 100 is rotatably connected to an end, away from the slider 300, of the second shell 200. By articulating one end of the first shell 100 with one end of the second shell 200 and slidably engaging the other end of the first shell 100 with the other end of the second shell 200, the protection performance of the drop-proof protective case is guaranteed, thereby guaranteeing the connection stability of the first shell 100 and the second shell 200 in the locked state, and facilitating state switching of the drop-proof protective case.

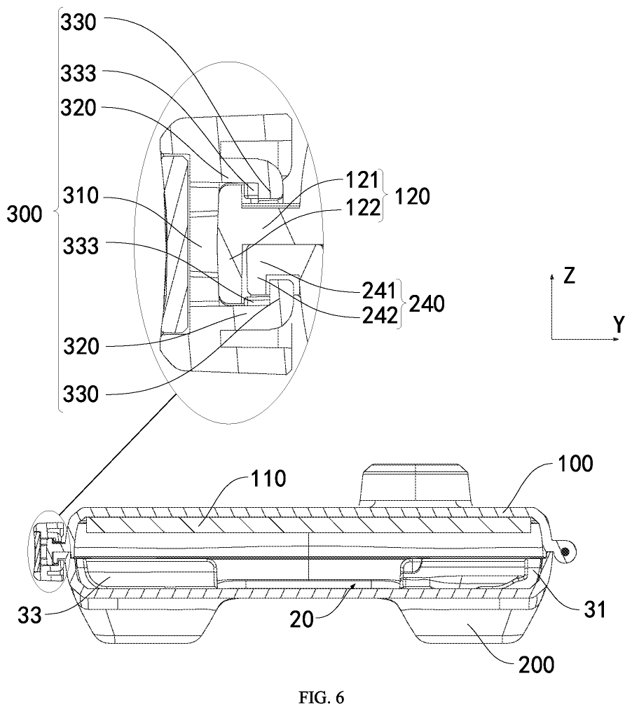

As shown in FIGS. 6-7 and 10, two second engaging portions 1211 are arranged. When the slider 300 is located in the second position, the slider 300 is disengaged from the first shell 100 or the second shell 200, i.e., the slider 300 is disengaged from the first connector 120 or the second connector 240, and one of the second engaging portions 1211 is engaged with the first engaging portion 331. When the slider 300 is located in the first position, the other second engaging portion 1211 is engaged with the first engaging portion 331. By means of the arrangement of the two second engaging portions 1211, when the slider 300 is located in the second position, the other second engaging portion 1211 is engaged with the first engaging portion 331, such that the slider 300 is prevented from sliding in the unlocked state.

As shown in FIGS. 6-7 and 10, two first engaging portions 331 are arranged. When the slider 300 is located in the second position, one of the first engaging portions 331 is engaged with one of the second engaging portions 1211. When the slider 300 is located in the first position, the other first engaging portion 331 is engaged with the other second engaging portion 1211. By means of the arrangement of the two first engaging portions 331, the two first engaging portions 331 may be kept away from each other, i.e., the two first engaging portions 331 are arranged close to two opposite ends of the slider 300 respectively, such that the distance from the first engaging portions 331 to ends of the slider 300 closest to the first engaging portions 331 is reduced, thereby reducing the movement distance required for engaging the second engaging portions 1211 with the first engaging portions 331; moreover, the size of the slider 300 in the first direction X is increased to facilitate operation by users (to be specific, users may slide the slider 300 easily).

As shown in FIGS. 6-7 and 10, the slider 300 moves in the first direction X. Second guide slopes 3311 are formed at two opposite ends of the first engaging portion 331 in the first direction X. Third guide slopes 12111 are formed at two opposite ends of the second engaging portion 1211 in the first direction X. By means of the arrangement of the second guide slopes 3311 and the third guide slopes 12111, the first engaging portion 331 may be easily separated from the second engaging portion 1211. The slider 300 is provided with a third engaging unit 330, the first engaging portion 331 is arranged on the third engaging unit 330, and first guide slopes 332 are formed at two opposite ends of the third engaging unit 330 in the first direction X. By means of the arrangement of the first guide slopes 332, the second engaging portion 1211 may be easily inlaid into the space between the third engaging unit 330 and the first shell 100 or the second shell 200, thereby facilitating the engagement between the first engaging portion 331 and the second engaging portion 1211.

The third direction Z specifically refers to a direction from the second shell 200 to the first shell 100. The first connector 120 includes a first extension unit 121 and a first engaging unit 122. The first engaging unit 122 is arranged at an end, away from the first shell 100, of the first extension unit 121 and extends in the third direction Z. The second connector 240 includes a second extension unit 241 and a second engaging unit 242. The second engaging unit 242 is arranged at an end, away from the second shell 200, of the second extension unit 241 and extends in an opposite direction of the third direction Z. The slider 300 includes a main body 310, two third extension units 320 and two third engaging units 330. The two third extension units 320 are arranged on a side, facing the first shell 100, of the main body 310 and are respectively close to two opposite ends of the main body 310 in the third direction Z. The two third engaging units 330 are respectively arranged at ends, away from the main body 310, of the two third extension units 320 and extend towards each other. The slider 300 is slidably arranged on the first connector 120, the second engaging portion 1211 is arranged on the first extension unit 121, and the first engaging portion 331 is arranged on the third engaging unit 330 close to the first connector 120.

The third direction Z is also the thickness direction of the shell 1000. The movement direction of the slider 300 from the second position to the first position is defined as the first direction X, and the first direction X is the length direction of the shell 1000.

In this embodiment, each of the two third engaging units 330 is provided with a sliding protrusion 333, and the sliding protrusions 333 extend towards the main body 310. The first connector 120 is T-shaped, i.e., at least a portion of the first engaging unit 122 extends in the opposite direction of the third direction Z, and at least a portion of the first engaging unit 122 extends in the third direction Z. When the slider 300 is assembled on the first connector 120, the first connector 120 is clamped by the sliding protrusions 333 and the main body 310, such that the slider 300 is restrained from moving in the first direction X.

As shown in FIGS. 6-7 and 10, in an implementation mode, when the slider 300 is located in the second position, i.e., in the unlocked state, the slider 300 is disengaged from the first connector 120 or the second connector 240. The movement direction of the slider 300 from the second position to the first position is defined as the first direction X. The first engaging portion 331 is a groove, the second engaging portion 1211 is a protrusion, and first guide slopes 332 are formed at two opposite ends of the third engaging unit 330 in the first direction X, such that the protrusion may be easily inlaid into the space below the third engaging unit 330. Second guide slopes 3311 are formed on two opposite sides of the groove in the first direction X, such that the protrusion may be easily disengaged from the groove. Third guide slopes 12111 are formed on two opposite sides of the second engaging portion 1211 in the first direction X, such that the protrusion may be easily engaged into the groove and easily disengaged from the groove.

In another implementation mode, when the slider 300 is located in the second position, i.e., in the unlocked state, the slider 300 is disengaged from the first connector 120 or the second connector 240. The movement direction of the slider 300 from the second position to the first position is defined as the first direction X. The first engaging portion 331 is a protrusion, the second engaging portion 1211 is provided with a groove, and first guide slopes 332 are formed at two opposite ends of the second engaging portion 1211 in the first direction X, such that the protrusion may be easily inlaid into the space above the second engaging portion 1211. Second guide slopes 3311 are formed on two opposite sides of the groove in the first direction X, such that the protrusion may be easily disengaged from the groove. Third guide slopes 12111 are formed on two opposite sides of the protrusion in the first direction X, such that the protrusion may be easily inlaid into the groove and easily disengaged from the groove.

As shown in FIGS. 6-7 and 10, when the slider 300 is located in the second position, the slider 300 is disengaged from the first connector 120 or the second connector 240. The movement direction of the slider 300 from the second position to the first position is defined as the first direction X. A stop portion 123 is arranged at each of two opposite ends of the first shell 100 or the second shell 200 in the first direction X, i.e., a stop portion 123 is arranged at each of two opposite ends of the first connector 120 or the second connector 240 in the first direction X, and the stop portions 123 are used for preventing disengagement of the slider 300.

In an implementation mode, the stop portion 123 at one end of the first connector 120 in the first direction X is used for preventing disengagement of the slider 300 caused by excessive displacement when the slider 300 is switched from the unlocked state into the locked state. The stop portion 123 at one end of the first connector 120 in the opposite direction of the first direction X is used for preventing disengagement of the slider 300 when the slider 300 is switched from the locked state into the unlocked state.

In this embodiment, the slider 300 is slidably arranged on the first connector 120, a stop portion 123 is arranged at each of two opposite ends of the first connector 120 in the first direction X, and the stop portions 123 are used for preventing disengagement of the slider 300. A stop portion 123 is arranged at one end of the second connector 240 in the first direction X and is used for preventing disengagement of the slider 300 caused by excessive displacement when the slider 300 is switched from the unlocked state into the locked state.

In another implementation mode, the slider 300 is slidably arranged on the second connector 240, and a stop portion 123 is arranged at each of two opposite ends of the second connector 240 in the first direction X and is used for preventing disengagement of the slider 300. A stop portion 123 is arranged at one end of the first connector 120 in the first direction X and used for preventing disengagement of the slider 300 caused by excessive displacement when the slider 300 is switched from the unlocked state into the locked state.

The above embodiment is merely used for explaining the technical solution of the present disclosure rather than limiting the present disclosure. Other modifications or equivalent substitutions made by those ordinarily skilled in the art without departing from the spirit and scope of the technical solution of the present disclosure should also fall within the scope of the claims of the present disclosure.

What is claimed is:

1. A drop-proof protective case, used for housing an electronic device, comprising a shell, the shell defining a receiving chamber, and elastic engaging parts being arranged on a side, facing the receiving chamber, of the shell, wherein a length direction of the electronic device is defined as a first direction, a width direction of the electronic device is defined as a second direction, and the elastic engaging parts are engaged with two opposite ends of the electronic device in the first direction and also engaged with two opposite ends of the electronic device in the second direction.

2. The drop-proof protective case according to claim 1, wherein the number of the elastic engaging parts is at least four, at least two of said elastic engaging parts are engaged with one side of the electronic device in the second direction and respectively engaged with two opposite sides of the electronic device in the first direction; and at least the other two elastic engaging parts are engaged with the other side of the electronic device in the second direction and respectively engaged with two opposite sides of the electronic device in the first direction.

3. The drop-proof protective case according to claim 1, wherein mounting grooves are formed in the shell, and the elastic engaging parts are mounted in the mounting grooves.

4. The drop-proof protective case according to claim 1, wherein when the electronic device is engaged by the elastic engaging parts, the electronic device is spaced apart from the shell.

5. The drop-proof protective case according to claim 1, wherein the electronic device comprises back keys, avoidance grooves are formed in the elastic engaging parts, and the avoidance grooves are used for avoiding the back keys.

6. The drop-proof protective case according to claim 1, wherein the electronic device comprises peripheral keys, at least two engaging protrusions are formed on each said elastic engaging part and are engaged with side edges, close to the peripheral keys, of the electronic device, and an avoidance space is formed between the two engaging protrusions and used for avoiding the corresponding peripheral key.

7. The drop-proof protective case according to claim 1, wherein a thickness direction of the electronic device is defined as a third direction; the shell comprises a first shell and a second shell, a first soft pad is arranged on an inner side of the first shell, and a second soft pad is arranged on an inner side of the second shell; and in a closed state, the first soft pad and the second soft pad respectively abut against two opposite sides of the electronic device in the third direction.

8. The drop-proof protective case according to claim 7, wherein the elastic engaging parts are arranged on the inner side of the second shell; and when the electronic device is housed in the second shell, a distance between the electronic device and the second soft pad in the third direction is less than a distance between the electronic device and the elastic engaging parts in the third direction.

9. The drop-proof protective case according to claim 7, wherein card slots are formed in the inner side of the second shell, and the card slots are used for storing electronic cards.

10. The drop-proof protective case according to claim 1, wherein the shell comprises a first shell, a second shell and a slider, the slider is slidably arranged on the first shell or the second shell, and when the slider is located in a first position, the slider is engaged with the first shell and the second shell; and when the slider is located in a second position, the slider is disengaged from the first shell or the second shell.

11. The drop-proof protective case according to claim 10, wherein the first shell is provided with a first connector, the second shell is provided with a second connector, and the slider is slidably arranged on the first connector or the second connector; when the slider is located in the first position, the slider is engaged with the first connector and the second connector; and when the slider is located in the second position, the slider is disengaged from the first connector or the second connector.

12. The drop-proof protective case according to claim 11, wherein the slider is provided with a first engaging portion, and the first connector and/or the second connector is provided with a second engaging portion; and when the slider is located in the first position, the first engaging portion is engaged with the second engaging portion to restrain the slider from sliding from the first position to the second position.
